(19) United States
(12) Patent Application Publication
(10) Pub. No.: US 2007/0050614 A1
(43) Pub. Date: Mar. 1, 2007

(54) Robust hyper-chaotic encryption-decryption system and method for digital secure-communication

(76) Inventors: Wen-Wei Lin, Taipei (TW); Chung-Hsi Li, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/503,276

(22) Filed: Aug. 14, 2006

Related U.S. Application Data
(63) Continuation-in-part of application No. 11/209,611, filed on Aug. 24, 2005.

(51) Int. Cl. H04L 9/00

(52) U.S. Cl. 713/150

(57) ABSTRACT

A robust hyper-chaotic encryption-decryption system, for digital secure-communication from a transmitter to a receiver, utilizing two robust hyper-chaotic means in the transmitter and receiver respectively, wherein the transmitter includes a hyper-chaotic signal generator and a transmitter's adjusting parameter device, and the receiver includes a hyper-chaotic synchronization receiver and a receiver's adjusting parameter device. A method is also disclosed, comprising an encryption and a decryption process wherein the encryption process including steps of decomposing a plaintext message into a sequence and carrying the sequence into a masking sequence of a hyper-chaotic signal via an XOR operation for generating a hyper-chaotic ciphertext, and the decryption process including steps of generating unmasking sequence of a hyper-chaotic signal to realize synchronization with the masking sequence after receiving the ciphertext and transforming the ciphertext into a decrypted plaintext massage via an XOR operation.

### CROSS-REFERENCE TO RELATED DOCUMENTS

The present invention is a continuation in part (CIP) to a U.S. patent application Ser. No. 11/209,611 entitled “System and method for hyper-chaos secure communication” filed on Aug. 24, 2005.

### BACKGROUND OF THE INVENTION

1. Field of the Invention

The present invention relates to a hyper-chaotic system and method for secure-communication, and more particularly, to a robust hyper-chaotic encryption-decryption system and method for digital secure-communication.

2. Description of the Prior Art

As computer and Internet are used widely, safety communication is getting more and more important. In common digital communications, most data are not encrypted and decrypted, that is, most digital communications are not confidential.

Besides, with the development of the chaotic technique, more and more researchers have been focused on the possible application of a chaotic system generated by a nonlinear system for secure-communication. The chaotic orbit generated by a nonlinear system is irregular, aperiodic, unpredictable and has sensitive dependence on initial conditions. Together with the development of chaotic synchronization between two nonlinear systems, chaotic system indeed has its role in secure-communication.

In a chaotic secure-communication, the chaotic signal are used as masking streams to carry information, which can be recovered by chaotic synchronization behavior between a transmitter and a receiver. However, most of previous work on chaotic secure-communication is mainly developed for analog signals, and only a limited number of researches focuses on the secure-communication of digital signals.

As to the researches on the digital secure-communication, although a chaotic system based on the logistic map is found that it is indeed can generate unpredictable sequences, with short precision, it will have a small number of total states and can be easily attacked by enumerating the states. Besides, even the system using the left-circulate function and feed-back loop with parameters may enhance the strength of security, but it also can be readily attacked under the assumption of “chosen plaintext”. On the other hand, many researches focus on attacking chaotic secure-communication and the result shows that it can be attacked by plotting the map with output sequence due to the unique map pattern of each single-chaotic map by which it is easy to distinguish the chaotic systems and to re-construct the equations.

To solve this problem, a lot of work focusing on enhancing the complexity of output sequences has been proposed. It can be classified into three major types. First, in order to have unpredictable initials, another chaotic map is used to generate the initials to a chaotic map. Second, multiple chaotic maps are used. At any time, application of a specific map is selected by a predefined order or a user defined mechanism. The third type is a combination of the two types mentioned above. It should be noted that these three methods essentially use still a one-dimensional system with only one positive Lyapunov exponent. This feature limits the complexity of the chaotic dynamics.

Moreover, the usable region of parameter value is a weakness of the discrete-time chaotic synchronization system. The chaotic behavior is dependent on the parameters. Unfortunately, all parameters are not equally strong. Some of them will result in “window”. Here a “window” is defined as the chaotic orbit of a nonlinear system visualized as periodic on computers. The remaining parameter space may easily be attacked by brute-force enumeration method because the parameter space is small.

Furthermore, a classic logistic map, L, is defined as

x(i+1)=L(γ,x(i))=γ x(i)(1−x(i)), x(i)∈[0,1], where γ is a parameter and 0≦γ≦4. In the equation above, when 3.57≦γ≦4, the generated sequence is non-periodic and non-converging. However, the parameters γ that result in “windows” of the equation above, for 3.57≦γ≦4, is open and dense. Moreover, the chaotic attractor is not distributed within the range of 0 to 1 and its length is less than 1. In this case, γ is easily detected by measuring the length of chaotic attractors. The only useful case of the equation above is when 65 =4 because its chaotic attractor is uniformly distributed in the range of 0 to 1. Therefore, selections of γ values are limited.

### SUMMARY OF THE INVENTION

In order to solve the problems mentioned above, we provide a robust hyper-chaotic encryption-decryption system and method for digital secure-communication that meets three features. First, the length of digital precision is long enough to prevent the system from being attacked by state enumeration. Second, the parameter space is large enough for practical use by means of a robust logistic function by which a robust logistic map is uniformly distributed and has a large parameter space. Finally, the re-construction of the chaotic system is infeasible using current computation technology. Thus, digital data can be encrypted in a transmitter, sent to a receiver, and decrypted in the receiver via the hyper-chaotic technique so that the secure-communication can be achieved.

The robust hyper-chaotic encryption-decryption system for digital secure-communication according to the present invention comprises a hyper-chaotic signal generator, located in the transmitter for carrying a plaintext message into a masking sequence of a hyper-chaotic signal; a transmitter's adjusting parameter device, located in the transmitter for adjusting parameters of the hyper-chaotic signal generator so that the hyper-chaotic signal generator can transform the plaintext massage and the masking sequence into a hyper-chaotic ciphertext, which is sent to the receiver via the hyper-chaotic signal generator; a hyper-chaotic synchronization receiver, located in the receiver for generating a unmasking sequence of a hyper-chaotic signal and transforming the hyper-chaotic ciphertext into a decrypted plaintext massage via an XOR operation for the unmasking sequence; a receiver's adjusting parameter device, for adjusting parameters of the hyper-chaotic synchronization receiver to cause the hyper-chaotic synchronization receiver generating the unmasking sequence to realize synchronization with the masking sequence after the receiver receiving the hyper-chaotic ciphertext.

The robust hyper-chaotic encryption-decryption method for digital secure-communication comprises an encryption process and a decryption process. The encryption process proceeding in the transmitter includes steps of: first, decomposing a plaintext message into a sequence of {p⁽ⁱ⁾}, and carrying the sequence of {p⁽ⁱ⁾} into a masking sequence of a hyper-chaotic signal via an XOR operation for generating a hyper-chaotic ciphertext. After sending the hyper-chaotic ciphertext to the receiver via the hyper-chaotic signal generator, the decryption process proceeding in the receiver including steps of generating a unmasking sequence of a hyper-chaotic signal to realize synchronization with the masking sequence after receiving the hyper-chaotic ciphertext, and transforming the hyper-chaotic ciphertext into a decrypted plaintext massage via an XOR operation.

In summary, the present invention can provide a larger parameter space, generate different ciphertexts with different initial vectors for the same plaintext massage, and provide in-complete carrier map transmitted in the public channel so that it is hard to re-construct the map even under the assumption of “chosen plaintext” attack and can achieve very high secure level. Besides, the present invention also can be easily realized by low cost hardware so that it further broadens the use of the present invention.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 shows a block diagram for a general secure-communication scheme.

FIG. 2 shows a block diagram of a robust hyper-chaotic encryption-decryption system for digital secure-communication according to the present invention.

FIGS. 3A˜3D shows the analysis result of a robust hyper-chaotic means according to the present invention by numerical method, that is, Lyapunov exponents vs. γ for n=2,3,4,10.

FIG. 4 shows the BER between S_{base} and S_{base±d×2}⁻⁴⁸ in an experiment designed to show the property that a generated masking sequence is very sensitive dependence on the parameters according to the present invention.

FIG. 5 shows the data flow of a first robust hyper-chaotic means within the hyper-chaotic signal generator in a demonstration according to the present invention.

FIG. 6 shows a block diagram of the first robust hyper-chaotic means within the hyper-chaotic signal generator in hardware in a demonstration according to the present invention.

FIG. 7 shows a table of the simulation result for demonstrating the first robust hyper-chaotic means with n=2 according to the present invention.

FIG. 8 shows a table of an encryption example in the encryption system for demonstrating the first robust hyper-chaotic means with n=2 according to the present invention.

### DETAILED DESCRIPTION OF THE PREFERRED EMBODIMENTS

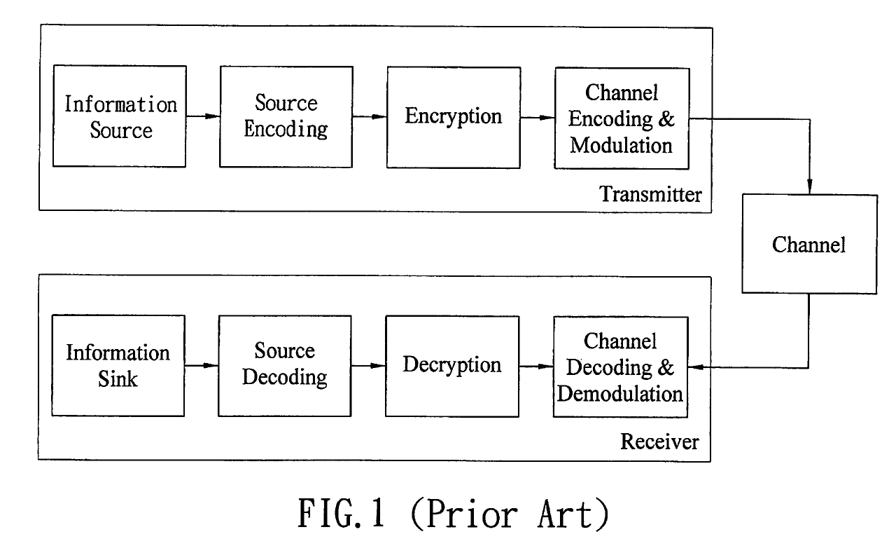

In a general secure-communication scheme, referring to FIG. 1, information is transmitted by Transmitter through channels after Sources Encoding, Encryption and Channel Encoding and Modulation. Receiver recovers the information by reversing these steps. In the present invention, correspondingly, the input is from the step of Sources Encoding and the output is sent to the step of Channel Encoding and Modulation.

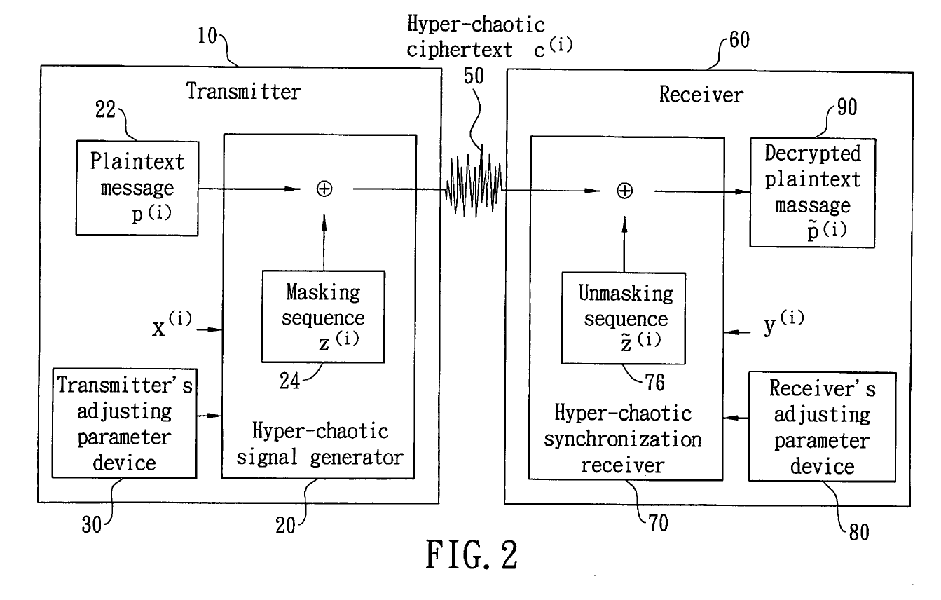

FIG. 2 is a block diagram of a robust hyper-chaotic encryption-decryption system for digital secure-communication according to the present invention. As shown in FIG. 2, the system includes a transmitter 10 and a receiver 60. The transmitter 10 includes a hyper-chaotic signal generator 20 and a transmitter's adjusting parameter device 30. The hyper-chaotic signal generator 20 is located in the transmitter. The hyper-chaotic signal generator 20 is used for carrying a plaintext message 22 into a masking sequence of a hyper-chaotic signal 24 of the hyper-chaotic signal generator 20. The transmitter's adjusting parameter device 30 is used for adjusting parameters of the hyper-chaotic signal generator 20, causing the hyper-chaotic signal generator 20 transforming the plaintext massage 22 and the masking sequence 24 into a hyper-chaotic ciphertext 50. The hyper-chaotic ciphertext 50 can be sent by the hyper-chaotic signal generator 20. The receiver 60 includes a hyper-chaotic synchronization receiver 70 and a receiver's adjusting parameter device 80. The receiver's adjusting parameter device 80 is used for adjusting parameters of the hyper-chaotic synchronization receiver 70, causing the hyper-chaotic synchronization receiver 70 generating a unmasking sequence of a hyper-chaotic signal 76 to realize synchronization with the masking sequence 24 after the receiver 60 receiving the hyper-chaotic ciphertext 50. And then the hyper-chaotic synchronization receiver 70 transforms the hyper-chaotic ciphertext 50 into a decrypted plaintext massage 90 via an XOR operation for the unmasking sequence 76.

In detail, the robust hyper-chaotic encryption-decryption system utilizes two robust hyper-chaotic means, wherein each robust hyper-chaotic means includes a plurality of robust logistic maps, a carrier map and several hidden maps. And the robust logistic map is a uniformly distributed map, having a larger parameter space and utilizing a robust logistic function defined as:

$$L ( γ , x ) = \{ \begin{matrix}γ x ( 1 - x ) ( mod 1 ) , & x ∈ {I}_{ext} \\ x ( 1 - x ) ( mod 1 ) / γ / 4 ( mod 1 ) , & x ∈ {I}_{int}\end{matrix} \\ where \\ {I}_{ext} ∈ ( 0 , 1 ) \backslash {I}_{int} , {I}_{int} = [ {η}_{1 ,} {η}_{2} ] , \\ {η}_{1} = 1 / 2 - \sqrt{1 / 4 - [ ( γ / 4 ) ] / γ} , \\ {η}_{2} = 1 / 2 + \sqrt{1 / 4 - [ ( γ / 4 ) ] / γ} ; \\ in which [ ω ] is the greatest integer less than or equal to ω$$

Based on the equation mentioned above, the γ range can be extended to a value more than 4. When L(γ,x) is greater than 1, the first equation is to shift the map value greater than 1 to the range of 0 to 1, wherein the modular one operation keeps x invariant in [0,1]. However, when x in the range Iᵢₙₜ, the mapping is not uniformly distributed, and results in “window” of the map. Therefore, when L(γ,x) is less than 1, the second equation is to scale the value to the range of 0 to 1. With both modular and scaling operations, the map can be made uniformly distributed in the range of 0 to 1.

Still referring to FIG. 2, the hyper-chaotic signal generator 20 functions by utilizing a first robust hyper-chaotic means, which can be defined as
x⁽ⁱ⁾=F(r,x⁽ⁱ⁻¹⁾):=C L(r,x⁽ⁱ⁻¹⁾), where x⁽ⁱ⁾=[x₁⁽ⁱ⁾, . . . , xₙ⁽ⁱ⁾]^{T},

L(r, x⁽ⁱ⁻¹⁾)=[L(γ1, x₁⁽ⁱ⁻¹⁾), . . . , L(γₙ, xₙ⁽ⁱ⁻¹⁾)]^{T}, in which L(r,x) is a robust logistic function mentioned above.

and C is a positive stochastic coupling matrix with all elements 0<cᵢⱼ<1 and

$${\sum }_{j} {c}_{ij} = 1$$

$$for$$

$$i , j = 1 , ⋯ , n . \\ ( \begin{matrix}{c}_{11} & {c}_{12} & … & {c}_{1 n} \\ {c}_{21} & {c}_{22} & … & {c}_{2 n} \\ … & … & & … \\ {c}_{n1} & {c}_{n2} & … & {c}_{nn}\end{matrix} )$$

In addition, the masking sequence 24 can be defined as z⁽ⁱ⁾=x₁⁽ⁱ⁾. It is generated by the hyper-chaotic signal generator in the transmitter according to the input of an initial vector and parameters, wherein the initial vector can be defined as x⁽⁰⁾=[x₁⁽⁰⁾, . . . , xₙ^{(0)]}^{T}, and the parameters includes an n-by-n stochastic matrix C=[cᵢⱼ] and a chaotic parameter vector r=[γ₁, . . . , γₙ]^{T}, where xᵢ⁽⁰⁾ ∈{(0,1)\{1/2})},γ₁≧4 for i=1, . . . ,n and 0<cᵢⱼ<1 for i,j=1, . . . ,n.

The hyper-chaotic synchronization receiver 70 functions by utilizing a second robust hyper-chaotic means, which can be defined as
y⁽ⁱ⁾=G(r,y⁽ⁱ⁻¹⁾):=C L(r,x⁽ⁱ⁻¹⁾), where y⁽ⁱ⁾=[y₁⁽ⁱ⁾, . . . , yₙ⁽ⁱ⁾]^{T} for i>0.

Besides, the unmasking sequence 76 can be defined as \tilde{z}⁽ⁱ⁾=y₁⁽ⁱ⁾. It is generated by the hyper-chaotic synchronization receiver 70 in the receiver 60 according to the input of an initial vector y⁽⁰⁾ and parameters.

It should be noted that the first robust hyper-chaotic means and the second robust hyper-chaotic means are in x⁽ⁱ⁾ and y⁽ⁱ⁾, respectively, with the same parameters of C and r.

When the plaintext massage 22 is carried into the transmitter 10 and decomposed into a sequence of {p⁽ⁱ⁾} and the real numbers of the first robust hyper-chaotic means are represented as m digits, the length of each p⁽ⁱ⁾ is equal to d digits and d=m−ι ∈N, for i≧1. Under the condition mentioned above, the encryption process proceeding in the hyper-chaotic signal generator 20 in the transmitter 10 can be defined as
z⁽ⁱ⁾=└x₁⁽ⁱ⁾┘_{ι},

c⁽ⁱ⁾=z⁽ⁱ⁾\textcircled{=}p⁽ⁱ⁾, where \textcircled{=} is an XOR operation, and └x₁┘_{ι} means dropping the first ι digits from x.

The decryption process proceeding in the hyper-chaotic synchronization receiver 70 can be defined as
\tilde{z}⁽ⁱ⁾=└y₁⁽ⁱ⁾┘_{ι},

\tilde{p}⁽ⁱ⁾=\tilde{z}⁽ⁱ⁾\textcircled{=}c⁽ⁱ⁾, wherein \tilde{p}⁽ⁱ⁾ is the decrypted plaintext massage 90.

It should be noted that the initial vector x⁽⁰⁾ of the transmitter 10 first is created randomly and then sent to the receiver 60 by replacing its initial vector y⁽⁰⁾ by x⁽⁰⁾. After this step, it holds that z⁽ⁱ⁾=\tilde{z}⁽ⁱ⁾ for i>0. Since the first robust hyper-chaotic means and the second robust hyper-chaotic means have the same initial vector and z⁽ⁱ⁾=\tilde{z}⁽ⁱ⁾ the ciphertext 50 can be correctly decoded, that is, \tilde{p}⁽ⁱ⁾=p⁽ⁱ⁾.

Besides, by the hiding the ι most significant digits in the communication, that is, these ι digits are dropped and not used in the encryption, the randomness of the masking sequence 24 is enhanced. The more hidden digits are used, the more difficult to analyze the ciphertext 50. However, the increased security is at the expense of more computing resource and hiding two-digits is found to have good randomness.

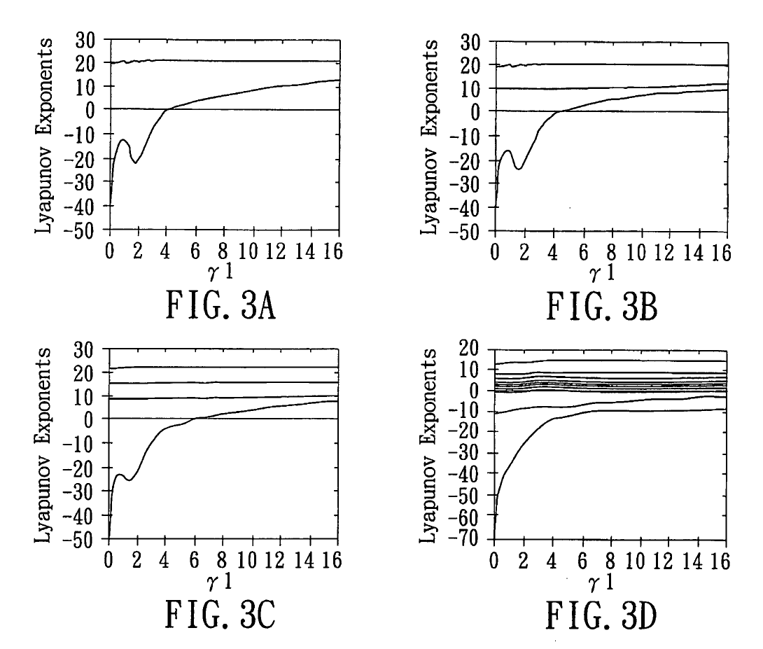

As mentioned above, the first and the second robust hyper-chaotic means are constructed by a plurality of coupled robust logistic maps (the number of coupled robust logistic maps is n) and each robust logistic map has its own positive Lyapunov exponent. To understand if the dimension of the means in terms of positive Lyapunov exponents is indeed increasing, the robust hyper-chaotic means is analyzed by numerical method. Since the higher dimension of the means, the more positive Lyapunov exponents the robust hyper-chaotic means has. Hence, it expects that the behavior of the output masking sequence (z⁽ⁱ⁾) 24 is more complex. The number of coupled robust logistic maps being set to two (i.e., n=2) is taken as an example. In this case, there are two parameters γ₁ land γ₂ for two robust logistic maps. In FIG. 3A, two Lyapunov exponents of 2-coupled robust logistic map are plotted for γ₁=0 to 16 with the scale of 1/30, and for a fixed γ₂=29.6668. The result shows that when γ₁≧4, two Lyapunov exponents are both positive, that is, the means is hyper-chaotic without “windows”. Similarly, the number of Lyapunov exponents for n=3,4,10, where values of γᵢ, 1<i≦n are fixed, and the range of γ₁ is from 0 to 16, are shown in FIG. 3B-3D, respectively. Thereby the number of positive Lyapunov exponents of the means are increasing without “window” as n increased, provided that all γᵢ in the means are larger than 4.

The following will show the cryptanalysis of the robust hyper-chaotic encryption-decryption system and it is based on an example where the precision of a number is 48-bits and the number of coupled robust maps is 2. With n=2 (n: the number of robust logistic maps), the first robust hyper-chaotic means is shown as:

$$\{ \begin{matrix}{x}_{1}^{( i )} = {c}_{11} L ( {γ}_{1} , {x}_{1}^{( i - 1 )} + ( 1 - {c}_{11} ) L ( {γ}_{2} , {x}_{2}^{( i - 1 )} ) \\ {x}_{2}^{( i )} = ( 1 - {c}_{22} ) L ( {γ}_{1} , {x}_{1}^{( i - 1 )} ) + {c}_{22} L ( {γ}_{2} , {x}_{2}^{( i - 1 )} )\end{matrix}$$

In this example, there are four parameters c₁₁, c₂₂, γ₁ and γ₂ and the total number of parameters that can be selected is 2^{4×48}=2¹⁹². It provides a much larger parameter space. In addition, the generated masking sequence 24 is very sensitive dependence on the parameters so that attackers cannot easily find the relationship between parameters and their corresponding masking sequences 24.

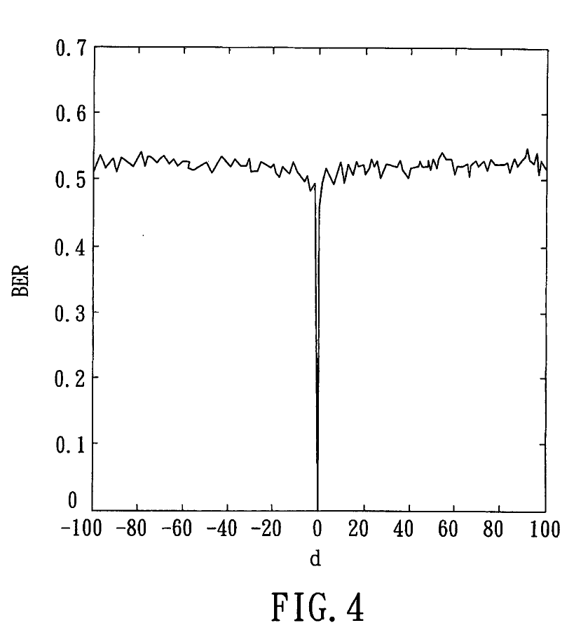

To show this property, an experiment is conducted. First, the first robust hyper-chaotic means in the equation above is taken as an example. Next, a set of C and r parameters is selected as base to generate a base masking sequence Sbase. Then, 200 γ₁ are generated by varying the least significant bits of base γ₁. With different γ₁ and the same γ₂ and C, 200 masking sequences are generated where S_{base±d×2}⁻⁴⁸, d=1, . . . ,100 denote the masking sequences. Finally, we compute bit error rate (BER) between S_{base} and S_{base±d×2}⁻⁴⁸. The result is shown in FIG. 4. It can be seen that the generated sequences are indeed different even with a small change by 2×2⁻⁴⁸ in one parameter.

Moreover, attackers may plot the map by analyzing output sequences of a chaotic map by rolling a means to compute the values of unknown parameters. Still based on the equation mentioned above, when i=1, the equation has five unknown variables, γ₁, γ₂, c₁₁, c₂₂ and x₂⁽¹⁾. Unrolling the means to i=4, attackers will have eight equations with additional three unknown variables, x₂⁽²⁾, x₂⁽³⁾ and x₂⁽⁴⁾. Totally, eight equations are given to solve right unknown variables. However, in the robust hyper-chaotic means, it is infeasible for an attacker to re-construct the map by rolling because of the following two features of the means. First, The masking sequence z⁽ⁱ⁾ 24 is an in-complete output sequence of the first robust hyper-chaotic means. The most significant ι digits are dropped, that is, z⁽ⁱ⁾ is not equal to x₁⁽ⁱ⁾. If there are four x₁⁽ⁱ⁾ in the equations, each of z⁽ⁱ⁾ drops j bits, the possible combinations of four x₁⁽ⁱ⁾ are (2^{j})⁴. Second, mapping is computed using the modular one operation in a robust logistic map. The piecewise non-linear map is not an one-to-one mapping. Given an output of L map, there are └γ/4┘×2 possible inputs. There are eight L maps need to be solved in this example. The combination of solutions are (└γ/4┘×2)⁸. Assuming the γ is less than 2,048, and j is 8, the attackers in total need to try (2⁸)⁴×1,024⁸ possible combinations of equations to solve the unknown variables taking the above two features into account. If a computer with 1 THz (Tera Hertz) CPU is used to run 10¹² cases per second, then for the above example, it requires near one million years to re-construct the first robust hyper-chaotic means. It is obvious that re-construction of the robust hyper-chaotic means is infeasible using current computation technology.

Furthermore, to demonstrate the effectiveness of the first robust hyper-chaotic means, it is implemented in hardware. The configuration of the means is selected as follow. The number of coupled robust logistic maps is 2. All real numbers in the means is represented by m=12 digits and the number of hidden digits, ι is 2. Then, in hexadecimal representation (one digit is 4 bits), the means operates in 49 bits (1 bit for sign bit). With 2 hidden digits, the length of one masking stream is 40 bits. Hence, the plaintext massage will be divided into segments of length 40 bits.

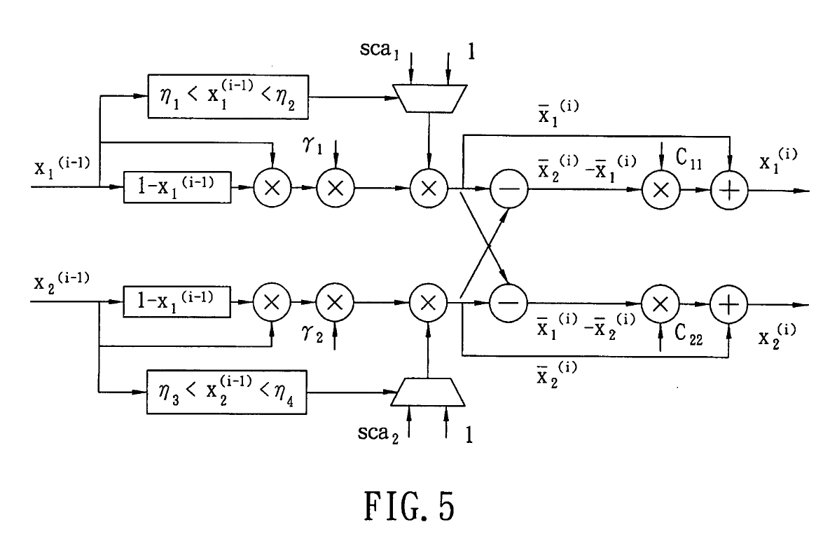

The data flow of the first robust hyper-chaotic means within the hyper-chaotic signal generator is shown in FIG. 5. In this flow, 8 multiplications are required to generate one masking sequence, z⁽ⁱ⁾. Inputs including x₁⁽ⁱ⁾ [symbol] x₂⁽ⁱ⁾ [symbol] γ₁ [symbol] γ₂ [symbol] c₁₁ and c₂₂ to the multiplication operations are 49 bits. sca₁ and sca₂ denote two scaling factors, 1/(γ₁/4)(mod1) and 1/(γ₂/4)(mod1), respectively, for normalization operation.

η₁=1/2−\sqrt{1/4−[(γ₁/4)]/γ₁}, η₂=1/2+\sqrt{1/4−[(γ₁/4)]/γ₁}, η₃1/2−\sqrt{1/4−[(γ₂/4)]/γ₂}, and η₄=1/2+\sqrt{1/4−[(γ₂/4)]/γ₂} denote the four conditions to determine if a modular or a scaling operation is to be performed. Since γ₁ and γ₂ are given by user and remain no change during operation, η₁, η₂, η₃, η₄, sca₁ and sca₂ are all input vectors to the means. When η₁<x₁⁽ⁱ⁻¹⁾<η₂(η₃<x₂⁽ⁱ⁻¹⁾<η₄), sca₁ (sca₂) is selected to scale the values of maps. Otherwise, constant 1 is multiplied.

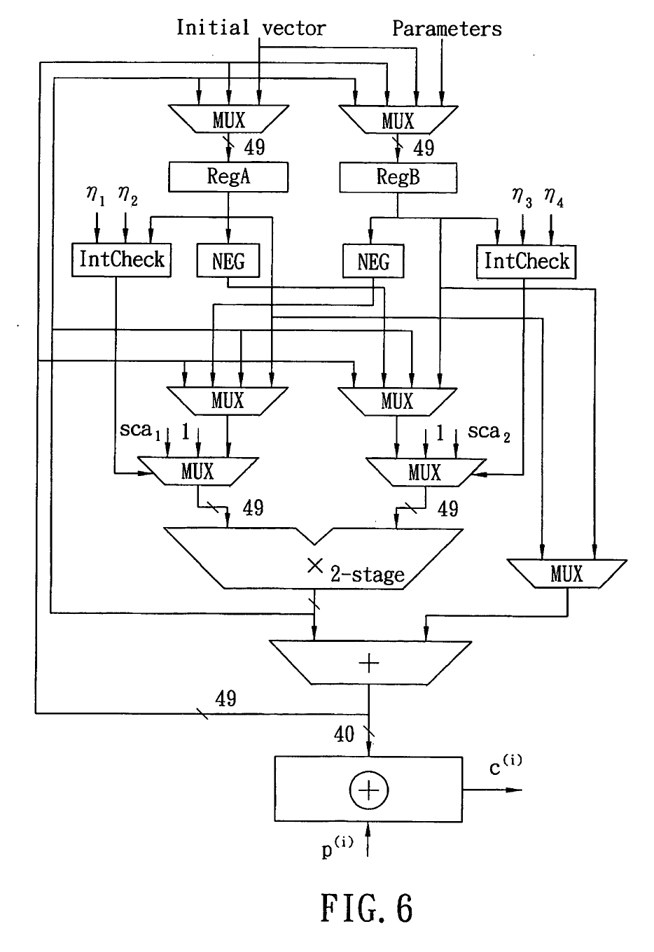

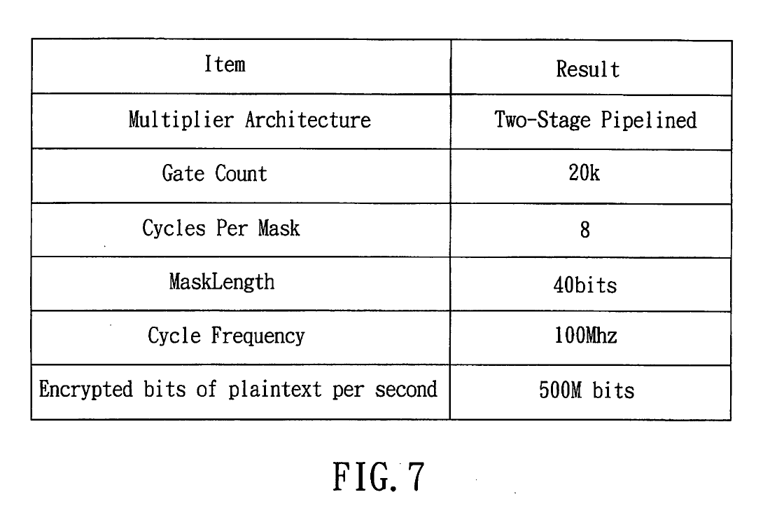

FIG. 6 shows the block diagram of the first robust hyper-chaotic means in hardware. For area and performance efficiency, a two stage pipelined multiplier is implemented. Hence, it requires 8 cycles to generate one masking sequence. Besides the 49-bits two-stage multiplier, the means has two 49-bits registers, “RegA” and “RegB”, for temporary data storage and four add/subtracters. Block “NEG” computes NEG(x)=1−x and block “IntCheck” is used to check if the input is in Iᵢₙₜ or not. The circuit is implemented in verilog format and synthesized with TSMC 0.13 μm process. FIG. 7 shows the simulation result. In this demonstration, the first robust hyper-chaotic means in the transmitter achieves an encryption rate of 500M bits per second based on the simulation of gate level netlist.

The first robust hyper-chaotic means with n=2 is demonstrated by using the following parameters.
x₁⁽⁰⁾=0.26e7bf70710c x₂⁽⁰⁾=0.3cebe4e04ecb
γ₁=15.000000000 γ₂=23.0000000000
c₁₁=0.fe0000000000 c₂₂=0.fa0000000000

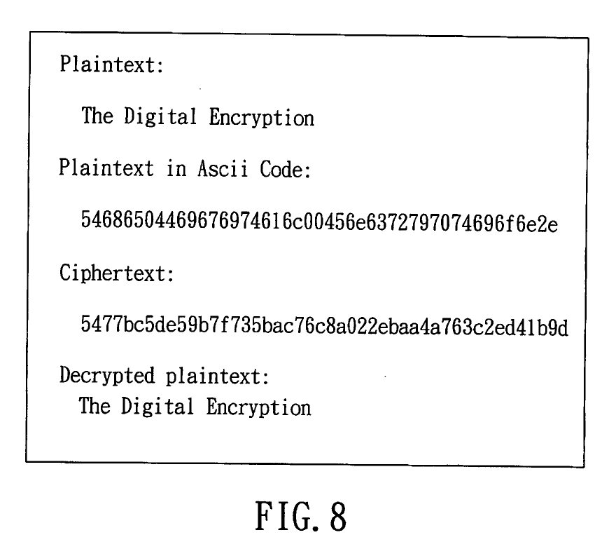

FIG. 8 shows encryption result of the plaintext massage “The Digital Encryption.” The plaintext massage is encoded into Ascii code format, and the data sequence will be encrypted by masking sequence generated by the first robust hyper-chaotic means with above parameters. The result also shows that the plaintext massage can be recovered with parameters in the receiver.

Accordingly, as disclosed in the above description and attached drawings, the present invention can provide a robust hyper-chaotic encryption-decryption system and method for digital secure-communication to convey data confidentially from a transmitter to a receiver. It is new and may be put into industrial use.

While the invention has been described with reference to certain embodiments and equations, it will be understood by those skilled in the art that various changes may be made and equivalents may be substituted without departing from the scope of the present invention.

What is claimed is:

1. A robust hyper-chaotic encryption-decryption system for digital secure-communication, used to convey data confidentially from a transmitter to a receiver, comprising:
a hyper-chaotic signal generator, located in the transmitter for carrying a plaintext message into a masking sequence of a hyper-chaotic signal;
a transmitter's adjusting parameter device, located in the transmitter for adjusting parameters of the hyper-chaotic signal generator, causing the hyper-chaotic signal generator transforming the plaintext massage and the masking sequence into a hyper-chaotic ciphertext;
a hyper-chaotic synchronization receiver, located in the receiver for generating unmasking sequence of a hyper-chaotic signal and transforming the hyper-chaotic ciphertext with the unmasking sequence into a decrypted plaintext massage via an XOR operation; and
a receiver's adjusting parameter device, located in the receiver for adjusting parameters of the hyper-chaotic synchronization receiver to cause the hyper-chaotic synchronization receiver generating the unmasking sequence to realize synchronization with the masking sequence after the receiver receiving the hyper-chaotic ciphertext.

2. The robust hyper-chaotic encryption-decryption system for digital secure-communication as claimed in claim 1, wherein the hyper-chaotic signal generator in the transmitter functions by utilizing a first robust hyper-chaotic means, which is constructed by a plurality of coupling robust logistic maps, one carrier map and several hidden maps.

3. The robust hyper-chaotic encryption-decryption system for digital secure-communication as claimed in claim 2, wherein the first robust hyper-chaotic means can be defined as
x⁽ⁱ⁾=F(r,x⁽ⁱ⁻¹⁾):=C L(r,x⁽ⁱ⁻¹⁾), where x⁽ⁱ⁾=[x₁⁽ⁱ⁾, . . . , xₙ⁽ⁱ⁾]^{T},
L(r, x⁽ⁱ⁻¹⁾)=[L(γ1, x₁⁽ⁱ⁻¹⁾), . . . , L(γₙ, xₙ⁽ⁱ⁻¹⁾)]^{T}, in which L(r,x) is a robust logistic function defined as
$$L ( γ , x ) = \{ \begin{matrix}γ x ( 1 - x ) ( mod 1 ) , & x ∈ {I}_{ext} \\ x ( 1 - x ) ( mod 1 ) / γ / 4 ( mod 1 ) , & x ∈ {I}_{int}\end{matrix} \\ where \\ {I}_{ext} ∈ ( 0 , 1 ) \backslash {I}_{int} , {I}_{int} = [ {η}_{1 ,} {η}_{2} ] , \\ {η}_{1} = 1 / 2 - \sqrt{1 / 4 - [ ( γ / 4 ) ] / γ} , \\ {η}_{2} = 1 / 2 + \sqrt{1 / 4 - [ ( γ / 4 ) ] / γ} ; \\ in which [ ω ] is the greatest integer less than or equal to ω$$
η₂=1/2+\sqrt{1/4−[(γ/4) ]/γ} in which [ω] is the greatest integer less than or equal to ω,
and C is a positive stochastic coupling matrix with all elements 0<cᵢⱼ<1 and
$${\sum }_{j} {c}_{ij} = 1$$
$$for$$
$$i , j = 1 , ⋯ , n . \\ ( \begin{matrix}{c}_{11} & {c}_{12} & … & {c}_{1 n} \\ {c}_{21} & {c}_{22} & … & {c}_{2 n} \\ … & … & & … \\ {c}_{n1} & {c}_{n2} & … & {c}_{nn}\end{matrix} )$$
the robust logistic map is defined as x(i+1)=L(γ, x(i)); and
the masking sequence generated by the hyper-chaotic signal generator is used to encrypt the plaintext massage and can be defined as z⁽ⁱ⁾=x₁⁽ⁱ⁾.

4. The robust hyper-chaotic encryption-decryption system for digital secure-communication as claimed in claim 1, wherein the hyper-chaotic synchronization receiver in the receiver functions by utilizing a second robust hyper-chaotic means, which is constructed by a plurality of coupling robust logistic maps, one carrier map and several hidden maps.

5. The robust hyper-chaotic encryption-decryption system for digital secure-communication as claimed in claim 4, wherein the second robust hyper-chaotic means can be defined as
y⁽ⁱ⁾=G(r,y⁽ⁱ⁻¹⁾):=C L(r,x⁽ⁱ⁻¹⁾), where y⁽ⁱ⁾=[y₁⁽ⁱ⁾, . . . , yₙ⁽ⁱ⁾]^{T} for i>0; and
the unmasking sequence generated by the hyper-chaotic synchronization receiver in the receiver is used to decrypt the ciphertext into decrypted plaintext massage and can be defined as \tilde{z}⁽ⁱ⁾=y₁⁽ⁱ⁾.

6. The robust hyper-chaotic encryption-decryption system for digital secure-communication as claimed in claim 1, wherein the parameters including an n-by-n stochastic matrix C=[cᵢⱼ] and a chaotic parameter vector r=[γ₁, . . . , γₙ]^{T}, where 0<cᵢⱼ<1 for i ,j=1, . . . ,n and γᵢ≧4 for i=1, . . . ,n.

7. The robust hyper-chaotic encryption-decryption system for digital secure-communication as claimed in claim 3, wherein when the parameter γ≧4, the number of positive Lyapunov exponents of the first robust hyper-chaotic means increases along with the number of robust hyper-chaotic maps utilized by the first robust hyper-chaotic means.

8. The robust hyper-chaotic encryption-decryption system for digital secure-communication as claimed in claim 5, wherein when the parameter γ≧4, the number of positive Lyapunov exponents of the second robust hyper-chaotic means increases along with the number of robust hyper-chaotic maps utilized by the second robust hyper-chaotic means.

9. The robust hyper-chaotic encryption-decryption system for digital secure-communication as claimed in claim 1, wherein the transmitter sending the hyper-chaotic ciphertext to the receiver is via the hyper-chaotic signal generator.

10. A robust hyper-chaotic encryption-decryption method for digital secure-communication, for conveying data confidentially from a transmitter to a receiver, comprising:
an encryption process, proceeding in the transmitter including the following steps in sequence: decomposing a plaintext message into a sequence of {p⁽ⁱ⁾}, generating a masking sequence of a hyper-chaotic signal according to the input of an initial vector x⁽⁰⁾ and parameters, and carrying the sequence of {p⁽ⁱ⁾} into the masking sequence via an XOR operation for generating a hyper-chaotic ciphertext; and
a decryption process, proceeding in the receiver including the following steps in sequence: generating a unmasking sequence of a hyper-chaotic signal according to the input of an initial vector y⁽⁰⁾ and parameters to realize synchronization with the masking sequence after receiving the hyper-chaotic ciphertext, and transforming the hyper-chaotic ciphertext into a decrypted plaintext massage via an XOR operation of the ciphertext and the unmasking sequence.

11. The robust hyper-chaotic encryption-decryption method for digital secure-communication as claimed in claim 10, wherein the initial vector x⁽⁰⁾ is created randomly first in the transmitter and is replaced by y⁽⁰⁾, and then it is sent to the receiver and is replaced again by x⁽⁰⁾.

12. The robust hyper-chaotic encryption-decryption method for digital secure-communication as claimed in claim 10, wherein the parameters including an n-by-n stochastic matrix C=[cᵢⱼ] and a chaotic parameter vector r=[γ₁, . . . ,γₙ]^{T}, where xᵢ⁽⁰⁾ ∈{(0,1)\{1/2}, γ₁≧4for i=1, . . . ,n and 0<cᵢⱼ<1 for i, j=1, . . . ,n.

13. The robust hyper-chaotic encryption-decryption method for digital secure-communication as claimed in claim 10, wherein when the real numbers of a first robust hyper-chaotic means are represented as m digits, the length of each p⁽ⁱ⁾ is equal to d digits and d=m−ι ∈N, for i≧1; and
under the condition mentioned above, the encryption process proceeding in the transmitter can be defined as
z⁽ⁱ⁾=└x₁⁽ⁱ⁾┘_{ι},
c⁽ⁱ⁾=z⁽ⁱ⁾\textcircled{=}p⁽ⁱ⁾, where \textcircled{=} is an XOR operation, and └x₁┘_{ι} means dropping the first ι digits from x.

14. The robust hyper-chaotic encryption-decryption method for digital secure-communication as claimed in claim 13, wherein based on the condition mentioned in claim 13, the decryption process proceeding in the receiver can be defined as
\tilde{z}⁽ⁱ⁾=└y₁⁽ⁱ⁾┘_{ι},
\tilde{p}⁽ⁱ⁾=\tilde{z}⁽ⁱ⁾\textcircled{+}c⁽ⁱ⁾, where \tilde{p}⁽ⁱ⁾ is the decrypted plaintext massage;

15. The robust hyper-chaotic encryption-decryption method for digital secure-communication as claimed in claim 10, wherein the transmitter sending the hyper-chaotic ciphertext to the receiver is via the hyper-chaotic signal generator.
